(19) United States
(12) Patent Application Publication
(10) Pub. No.: US 2024/0078996 A1
(43) Pub. Date: Mar. 7, 2024

(54) MODEL LEARNING SYSTEM, MODEL LEARNING METHOD, A NON-TRANSITORY COMPUTER-READABLE RECORDING MEDIUM, AN ANIMATION GENERATION SYSTEM, AND AN ANIMATION GENERATION METHOD

(71) Applicant: Square Enix Co., Ltd., Tokyo (JP)

(72) Inventors: Leandro Graciá Gil, Tokyo (JP); Masato Nakada, Tokyo (JP)

(21) Appl. No.: 18/456,002

(22) Filed: Aug. 25, 2023

(30) Foreign Application Priority Data
Aug. 25, 2022 (JP) 2022-133949

(51) Int. Cl. G10L 15/02; G10L 13/027

(52) U.S. Cl. CPC G10L 15/02; G10L 13/027

(57) ABSTRACT

Embodiments of the present disclosure provide methods, systems and non-transitory computer readable media of performing voice model learning and rig model learning. The voice model learning includes extracting an acoustic feature value by executing predetermined acoustic signal processing with respect to voice data including human voice and extracting a voice feature value by executing first transformation processing with respect to first input information including the extracted acoustic feature value. The rig model learning includes extracting a frame feature value by executing second transformation processing with respect to second input information including the extracted voice feature value and outputting character control information for controlling a character from the extracted frame feature value.

### CROSS-REFERENCE TO RELATED APPLICATION(S)

The present disclosure claims priority to and the benefit of Japanese Patent Application No. 2022-133949, filed on Aug. 25, 2022, the disclosure of which is expressly incorporated herein by reference in its entirety for any purpose.

### BACKGROUND

The present disclosure relates to a model learning system, a model learning method, a non-transitory computer-readable recording medium, an animation generation system, and an animation generation method.

There is a technology called LipSync for moving lips like speaking a language in accordance with voice data of a character. The applicant has published examples of a technology for generating a lip-sync animation based on voice data. Such examples may be found in, for example, JP2020-184100A.

### SUMMARY

Further improvements are desired to generate a stable lip-sync animation.

A purpose of at least one embodiment of the present disclosure is to provide a new model learning apparatus that generates a more natural animation.

According to a non-limiting aspect, the present disclosure is to provide a model learning apparatus comprising: a voice model learning apparatus including an acoustic feature value extraction unit that extracts an acoustic feature value by executing predetermined acoustic signal processing with respect to voice data including human voice, and a voice feature value extraction unit that extracts a voice feature value by executing first transformation processing with respect to first input information including the extracted acoustic feature value, and a rig model learning apparatus including a frame feature value extraction unit that extracts a frame feature value by executing second transformation processing with respect to second input information including the extracted voice feature value, and a character control information output unit that outputs character control information for controlling a character from the extracted frame feature value.

According to a non-limiting aspect, the present disclosure is to provide a model learning method comprising: extracting an acoustic feature value by executing predetermined acoustic signal processing with respect to voice data including human voice, extracting a voice feature value by executing first transformation processing with respect to first input information including the extracted acoustic feature value, extracting a frame feature value by executing second transformation processing with respect to second input information including the extracted voice feature value, and outputting character control information for controlling a character from the extracted frame feature value.

According to a non-limiting aspect, the present disclosure is to provide a non-transitory computer-readable recording medium having recorded thereon a model learning program executed in a computer apparatus, the program causing the computer apparatus to perform functions comprising: a voice model learning program causing the computer apparatus to execute extracting an acoustic feature value by executing predetermined acoustic signal processing with respect to voice data including human voice, and extracting a voice feature value by executing first transformation processing with respect to first input information including the extracted acoustic feature value, and a rig model learning program causing the computer apparatus to execute extracting a frame feature value by executing second transformation processing with respect to second input information including the extracted voice feature value, and outputting character control information for controlling a character from the extracted frame feature value

### BRIEF DESCRIPTION OF THE DRAWINGS

FIG. 1 is a block diagram illustrating an example machine learning model according to at least one embodiment of the disclosure.

FIG. 2 is a diagram representing a log-mel spectrogram of voice data according to at least one embodiment of the disclosure.

FIG. 3 is a diagram for illustrating a learning method using the log-mel spectrogram according to at least one embodiment of the disclosure.

FIGS. 4A and 4B are diagrams for illustrating setting of a convolutional neural network according to at least one embodiment of the disclosure.

FIG. 5 is a block diagram for illustrating a configuration of a residual block according to at least one embodiment of the disclosure.

FIG. 6 is a diagram for illustrating output of a voice feature value using an audio feature value as input according to at least one embodiment of the disclosure.

FIGS. 7A and 7B are diagrams for illustrating a style value according to at least one embodiment of the disclosure.

FIG. 8 is a diagram for illustrating a combination of sets of style embedding information according to at least one embodiment of the disclosure.

FIG. 9 is a diagram for illustrating a frame feature value extraction method according to at least one embodiment of the disclosure.

FIG. 10 is a diagram for illustrating an output method of transform information according to at least one embodiment of the disclosure.

FIG. 11 is a diagram for illustrating an output method of a pose weight according to at least one embodiment of the disclosure.

FIG. 12 is a diagram for illustrating a method of pre-training a voice model according to at least one embodiment of the disclosure.

### DETAILED DESCRIPTION

Hereinafter, an embodiment of the disclosure will be described with reference to the accompanying drawings. Description related to an effect below is one aspect of an effect of the embodiment of the disclosure, and the disclosure is not limited to the description. In addition, an order of each processing constituting a flowchart described below may be changed without contradiction or inconsistency in processing content.

### First Embodiment

A summary of a first embodiment of the disclosure will be described. Hereinafter, a model learning apparatus that outputs character control information for controlling a character including a facial expression of the character from voice data including human voice will be illustratively described as the first embodiment. The model learning apparatus is a subject of the embodiment unless otherwise specified.

In the first embodiment of the disclosure, implementation of the apparatus is not limited to hardware implementation. The apparatus may be implemented in a computer as software, and an embodiment of the apparatus is not limited. For example, implementation may be performed by installation on a dedicated server connected to a client terminal such as a personal computer through a wired or wireless communication line (an Internet line or the like), or implementation may be performed using a so-called cloud service.

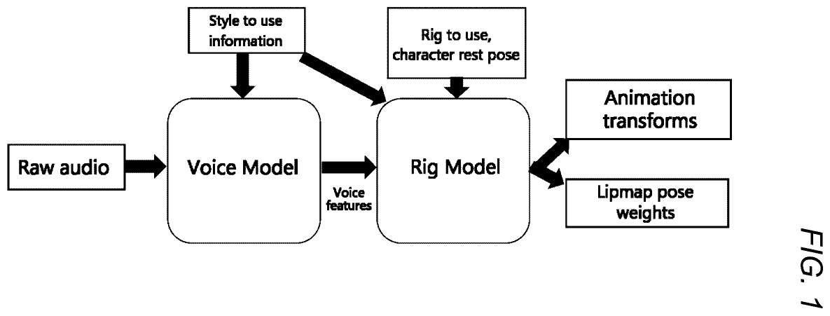

FIG. 1 is a block diagram illustrating a summary of a machine learning model according to at least one embodiment of the disclosure. A model learning apparatus 1 is configured with two types of separated sub-models including a voice model and a rig model.

The voice model takes the voice data including the human voice and style information of any language as input. Predetermined acoustic signal processing is performed to output a voice feature value that is a feature value as an input value for machine learning.

The rig model takes the voice feature value output by the voice model, the style information, information related to a rig to be used, and a bind pose of the character as input. Predetermined processing is performed to output the character control information related to an animation of the character. The character control information may include, for example, transform information of the animation and a pose weight.

### Voice Model—Acoustic Signal Processing

Next, the acoustic signal processing in the voice model in the first embodiment of the disclosure will be described. In a case where the voice data is received, the voice model first transforms the voice data into monaural sound. Next, a frequency of the voice data is set to a predetermined frequency bandwidth (resampling). The predetermined frequency bandwidth with which a frequency bandwidth of the human voice can be appropriately perceived may be used. For example, the predetermined frequency bandwidth is 19.2 kHz.

Next, the processed voice data is transformed into a spectrogram using short-time Fourier transform. Here, for example, a window width is set to 200 samples, and Fourier transform is performed while a window is moved by 160 samples at a time. Since a sampling rate of the voice is 19.2 kHz, 120 outputs are generated for every second of the voice in this processing (19200/160=120). Each output covers the voice of approximately 10 ms and has an overlap of 20% with the subsequent output.

In the spectrogram, an axis in a horizontal direction denotes time, an axis in a vertical direction denotes a frequency, and a value denotes volume. The spectrogram is transformed into a mel scale (hereinafter, referred to as a “mel spectrogram”) to further approximate human perception. The mel scale refers to a logarithmic scale based on human frequency perception.

Transformation into the mel scale has an effect of logarithmically extending the axis of the spectrogram in the vertical direction. Accordingly, it is possible to further prioritize a frequency difference in a low frequency bandwidth and to ignore a frequency difference in a high frequency bandwidth.

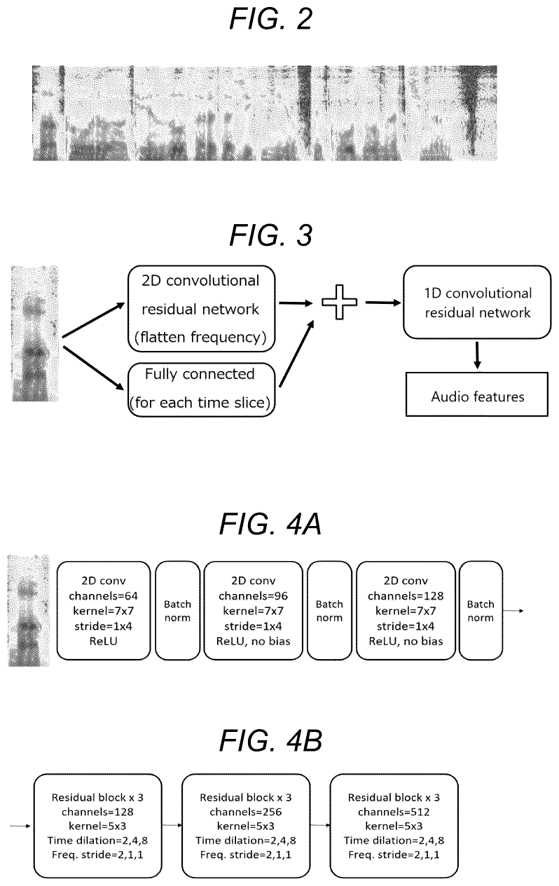

Human perception of the volume is also logarithmic like the frequency. The value of the volume in the mel spectrogram is linear. Thus, a logarithm of the value of the mel spectrogram is calculated (hereinafter, referred to as a log-mel spectrogram) to further approximate human volume perception. FIG. 2 is a diagram representing the log-mel spectrogram of voice data according to at least one embodiment of the disclosure.

FIG. 3 is a diagram for illustrating a learning method using the log-mel spectrogram according to at least one embodiment of the disclosure.

Movement of an image of the log-mel spectrogram in the horizontal direction represents a change in time. Movement of the image of the log-mel spectrogram in the vertical direction represents an approximate pitch change. A two-dimensional convolutional neural network is used to learn a feature value that is invariant to both of time and pitch. Here, output is based on relative pitch to prioritize a relationship between frequencies rather than an absolute value of the frequency.

Meanwhile, simple processing is also performed on each column of the image as a vector of frequency information. Here, output is based on absolute pitch using the absolute value of the frequency. Both output results are combined with each other. A method of combining the output results with each other will be described later.

Combining absolute information can improve quality for several phonemes.

### Convolutional Network

The used convolutional neural network will be described. This network generates one-dimensional output that changes in time. A height of the image can be reduced stepwise by transferring information to a depth channel.

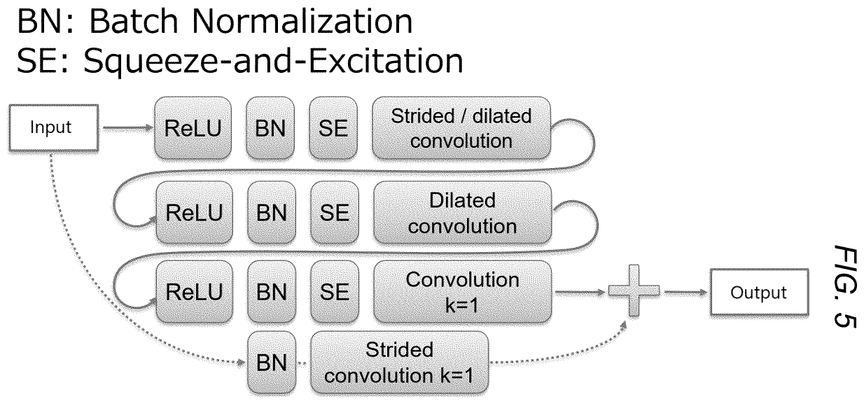

FIGS. 4A and 4B are diagrams for illustrating setting of the convolutional neural network according to at least one embodiment of the disclosure. FIG. 4A represents a head part of the network. Three different two-dimensional convolutional neural layers are applied while the number of channels is increased. A rear portion of each layer is followed by batch normalization. Each layer reduces the height of the image to ¼ of that in a case where the image is input.

FIG. 4B illustrates a network following the network in FIG. 4A. Three sets of three custom residual blocks set with different time dilation are applied. Using time dilation can significantly improve a sensory area on the time axis, and the network can adapt to a change in a speed of the voice.

Each set of the residual blocks doubles a channel depth and reduces the height of the image to half. In a case where processing in the last set of the residual blocks is performed, the image is flattened and can be used as a one-dimensional vector.

### Configuration of Residual Block

FIG. 5 is a block diagram for illustrating a configuration of the residual block according to at least one embodiment of the disclosure. The residual block in the first embodiment of the disclosure is based on a pre-activation ResNet block, and squeeze-and-excitation is applied to the residual block in addition to time dilation.

In the first convolution, dilation and stride are performed. In the second convolution, dilation using a target kernel size is applied. The third convolution is performed in the same manner as a layer in which each depth channel is fully connected by setting the kernel size to 1.

The dotted line in the lower portion is a shortcut pass of the ResNet block, and gradient information can be transmitted almost without effects of other blocks. Strided convolution is used for maintaining consistency between input and output sizes in adding the results.

Combination of the results of the relative pitch and the absolute pitch with each other in FIG. 3 uses the above-described convolutional network and residual block. It should be noted that the convolutional network of one dimension instead of two dimensions is used.

Performing such processing can obtain an audio feature value (also referred to as an acoustic feature value).

### Extraction of Voice Feature Value

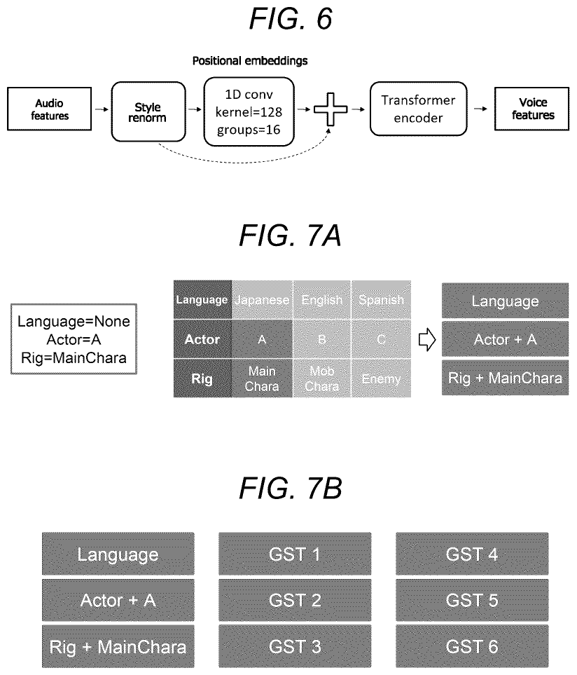

Next, acquisition of the voice feature value will be described. FIG. 6 is a diagram for illustrating output of the voice feature value using the audio feature value as input according to at least one embodiment of the disclosure.

First, the audio feature value is normalized based on the language style information. Normalization using the style information will be described later. Then, the voice feature value can be acquired by calculating a positional embedding using a one-dimensional convolutional network and by transforming a result of the calculation using a single transformer encoder. Here, attention in the transformer encoder is preferably restricted to only the audio feature value of one second before and after each moment.

### Style Normalization

For example, there are a plurality of types of styles such as a language, a character, and a rig, and each style has a set of independent values. For example, the language style may be Japanese, English, or other languages. Information included in the style may be set based on training data. The training data will be described later.

FIGS. 7A and 7B are diagrams for illustrating a style value according to at least one embodiment of the disclosure. The style of the rig may have, for example, types of characters used in a game. More specific examples include a rig for a main character, a rig for a mob character, and a rig for an enemy character.

It is also possible not to set the style with a value. In this case, a more general result may be generated. In a case where the style is not set with a value, the style can be used in adding a new character or a new language not present in the training data.

As illustrated in FIG. 7A, an embedding for each style and an embedding for each possible value of the style are learned, and two embeddings are added as a pair based on a selected used style. In a case where the style is not set with a value, only the embedding of the style is used. For example, in FIG. 7A, since the language style is not set with a specific value, the embedding of the language style is used. In addition, the embedding of the style value is initialized to 0. Thus, the style having a small number of samples in the training data is approximated to a result in a case where the style value is not set.

FIG. 7B is a diagram for illustrating embeddings of data using global style tokens. One embedding can be obtained for each input style by performing setting as in FIG. 7A. Global style tokens (GSTs) shared by all data are added to this set of embeddings. These are learned embeddings shared by all training data independently of the style. The model learning apparatus can perceive other aspects not explicitly defined as a set of styles by a person.

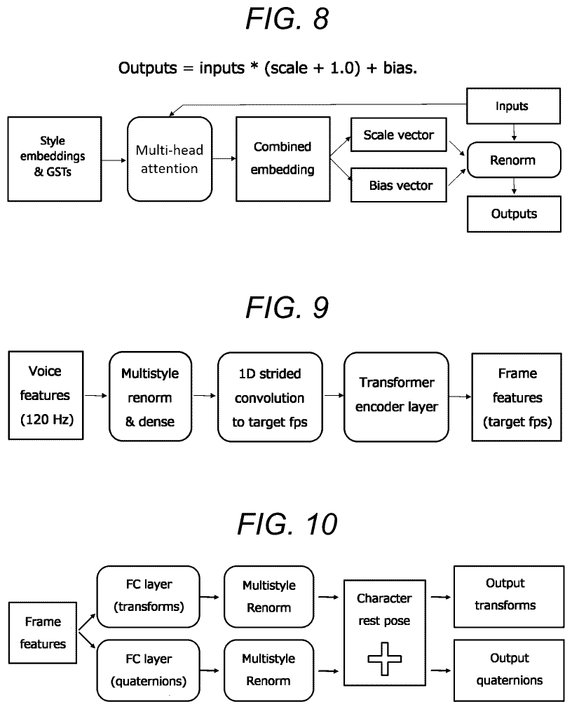

FIG. 8 is a diagram for illustrating combination of sets of style embedding information according to at least one embodiment of the disclosure. Here, multi-head attention is used. Attention is executed between the value at each moment and all embeddings using any input to be normalized. Consequently, the embedding combined for each moment is obtained and is divided into a scale vector and a bias vector having the same size. The input data is normalized using the scale vector and the bias vector.

### Rig Model—Frame Feature Value Extraction Unit

Next, a frame feature value extraction method of the rig model will be described. FIG. 9 is a diagram for illustrating the frame feature value extraction method according to at least one embodiment of the disclosure.

First, style normalization is performed with respect to the voice feature value. Here, the rig model uses all available style information unlike the voice model that uses only the language style. Here, only the scale vector is used in the normalization.

Then, a fully connected layer having activation is applied using a rectified linear unit (ReLU; a ramp function).

Next, one-dimensional convolution with an appropriate stride is applied. For example, this is performed to downscale a frequency of the voice feature value fixed to 120 Hz to a target FPS (example: 30 fps) of the animation. For transformation into 30 fps, the stride may be set to 4. Then, a frame feature value can be acquired in a case where another single transformer encoder is applied.

### Output of Character Control Information

Next, information output from the frame feature value will be described. In the first embodiment of the disclosure, the transform information of the animation and information related to the pose weight are output from the frame feature value. FIG. 10 is a diagram for illustrating an output method of the transform information according to at least one embodiment of the disclosure.

Output of the transform information of the animation can generate a high-quality result such as that used in a cutscene. This output may be transformed into an FBX format later.

Generation of this data uses a fully connected layer for outputting a transform of a bone from the frame feature value. The data is generated by performing normalization again with a plurality of styles and by adding the normalization result to the bind pose of the target character.

Even in a case where rotation is represented as Euler angles in the transform, the same processing is independently performed with respect to rotation based on a quaternion format. Doing so can stabilize training of the model. Both of the quaternion and the Euler angles can be generated from the internal rotation representation.

### Output of Pose Weight

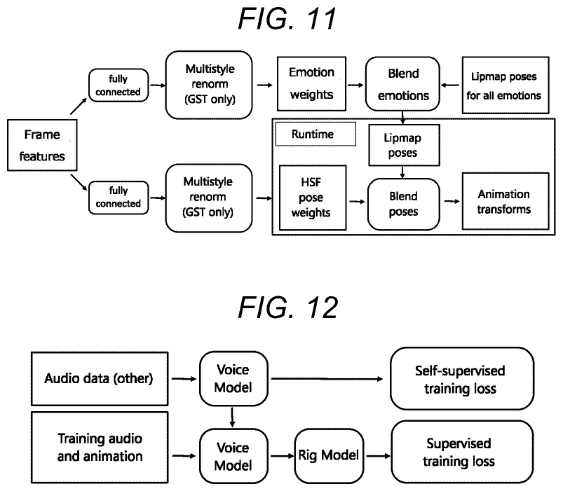

Next, output of information related to the pose weight will be described. FIG. 11 is a diagram for illustrating an output method of the pose weight according to at least one embodiment of the disclosure.

Here, pose weights for blending a pose set corresponding to a provided emotion are generated, and the weights are stored in a file for runtime use.

Emotion weights are also generated to expose the model to all possible emotions. One pose set is obtained by blending Lipmap poses with respect to all emotions using the emotion weights. Then, the obtained pose set is blended using the pose weight of Lipmap.

A fully connected layer is applied to the frame feature value in the same manner as that for the transform information of the animation, and normalization using a plurality of styles is applied to the application result to generate the information related to the pose weight. However, in this case, the style embedding is not used, and only the global style tokens (GSTs) shared by all training data are used.

As illustrated in FIG. 11, in model inference, the pose weight of Lipmap (HSF) is generated and stored in a file. On the other hand, in runtime, the pose weight of Lipmap (HSF) and the poses of Lipmap are loaded and blended to obtain an animation transform.

### Learning Method

In the first embodiment of the disclosure, there are currently two types of learning methods that are effective as a method of training the model. One is end to end learning (E2E learning). This is a method of training both of the voice model and the rig model at the same time with an approach of general supervised learning using the voice data and animation data included in the training data.

### Training Data

The voice data and the lip-sync animation synchronized with each other from the cutscene of already existing video data are used in the training data. As an example, the voice data and the lip-sync animation of a total of three and a half hours are used, and these cover 53 characters, three types of different facial rigs, and two languages of Japanese and English.

In a case where data included in the training data is short, this can be solved by randomly connecting to extend a plurality of short clips of the same character or of the same language. In addition, to improve robustness with respect to a speed of the voice or a change in a pitch caused by different characters, accuracy of the training data is increased by adding a copy of a clip in which speeds of audio and the animation are randomly changed, or by adding a copy of a clip in which a pitch of the audio is randomly changed while the speed of the audio is maintained.

### Loss Function

A loss function used here is L1 error between the animation data of the training data and the generated animation transform. Error of the animation transform in all outputs including Lipmap is calculated. Generation of the pose weight of Lipmap is learned by simple error backpropagation performed through Lipmap blending.

To avoid a cost of the error backpropagation performed through a bone hierarchy used in Maya, the output is normalized within a numerical range of the transform of the bone included in the training data. Accordingly, a high-quality animation can be generated.

In addition, a weight with which the error is increased based on a difference between the training data and the bind pose is added. This is because since a mouth is closed in the bind pose, the generated model is prevented from frequently failing to close the mouth in processing several phonemes.

Another learning method is a method of pre-training the voice model using self-supervised learning that initially requires only the voice data. FIG. 12 is a diagram for illustrating the method of pre-training the voice model according to at least one embodiment of the disclosure.

In this case, the voice model that is pre-trained to train the rig model is used. First, the rig model is trained by fixing the weight of the voice model. Then, in a case where the rig model is sufficiently trained, the voice model is fine-tuned.

Since plenty of open-domain audio (voice data) that can be used for learning is available online, it is easy to employ the method of pre-training the voice model.

The voice model and the rig model tuned using the above-described procedure may be generated and designed as an animation generation apparatus, an animation generation method, and an animation generation program.

Apart from the above description, an information processing system including a computer apparatus may be used as the first embodiment. The information processing system is configured with at least one computer apparatus. The computer apparatus includes, as an example, a control unit, a RAM, a storage unit, a sound processing unit, a graphics processing unit, a communication interface, and an interface unit that are connected to each other through an internal bus. The graphics processing unit is connected to a display unit. The display unit may include a display screen and a touch input unit that receives input based on contact of a player on the display unit.

The touch input unit may be able to detect a position of the contact using a method of any of a resistive film method, an electrostatic capacitive method, an ultrasonic surface acoustic wave method, an optical method, or an electromagnetic induction method used in a touch panel, and the method is not limited as long as an operation performed by a touch operation of the user can be recognized. The touch input unit is a device that can detect a position of a finger or the like in a case where an operation of, for example, pressing or moving on an upper surface of the touch input unit with a finger, a stylus, or the like is performed.

An external memory (for example, an SD card) may be connected to the interface unit. Data read from the external memory is loaded into the RAM, and calculation processing is executed by the control unit.

The communication interface can be connected to a communication network in a wireless or wired manner and can receive data through the communication network. The data received through the communication interface is loaded into the RAM, and calculation processing is performed by the control unit, in the same manner as the data read from the external memory.

The computer apparatus may include a sensor such as a proximity sensor, an infrared sensor, a gyro sensor, or an acceleration sensor. In addition, the computer apparatus may include an imaging unit that has a lens and that performs imaging through the lens. Furthermore, the computer apparatus may be a terminal apparatus that can be mounted (wearable) on a human body.

As one aspect of the first embodiment, a new model learning apparatus that generates a more natural animation can be provided.

In the first embodiment, the “acoustic feature value” refers to, for example, a numerical value representing a feature of sound. The “voice feature value” refers to, for example, a feature value as an input value for machine learning. The “frame feature value” refers to, for example, a numerical value representing a feature included in a frame. The “computer apparatus” refers to, for example, a stationary game console, a portable game console, a wearable terminal, a desktop or laptop personal computer, a tablet computer, or a PDA and may be a portable terminal such as a smartphone including a touch panel sensor on a display screen.

### (Appendix)

The above description of the embodiment is provided to enable those having ordinary knowledge in the field of the disclosure to embody the following disclosure.

(1) A model learning apparatus including
a voice model learning apparatus including
   an acoustic feature value extraction unit that extracts an acoustic feature value by executing predetermined acoustic signal processing with respect to voice data including human voice, and
   a voice feature value extraction unit that extracts a voice feature value by executing first transformation processing with respect to first input information including the extracted acoustic feature value, and
   a rig model learning apparatus including
      a frame feature value extraction unit that extracts a frame feature value by executing second transformation processing with respect to second input information including the extracted voice feature value, and
      a character control information output unit that outputs character control information for controlling a character from the extracted frame feature value.

(2) The model learning apparatus according to (1), further including
a training data storage unit that stores training data including voice and information related to an animation of the character as an answer, and
a learning model update unit that updates parameters of the voice model learning apparatus and the rig model learning apparatus based on a difference between the information related to the animation of the character included in the training data and the character control information output using the training data.

(3) A model learning method including
a step of extracting an acoustic feature value by executing predetermined acoustic signal processing with respect to voice data including human voice,
a step of extracting a voice feature value by executing first transformation processing with respect to first input information including the extracted acoustic feature value,
a step of extracting a frame feature value by executing second transformation processing with respect to second input information including the extracted voice feature value, and
a step of outputting character control information for controlling a character from the extracted frame feature value.

(4) A model learning program including
a voice model learning program causing a computer apparatus to execute
   a step of extracting an acoustic feature value by executing predetermined acoustic signal processing with respect to voice data including human voice, and
   a step of extracting a voice feature value by executing first transformation processing with respect to first input information including the extracted acoustic feature value, and
a rig model learning program causing a computer apparatus to execute
   a step of extracting a frame feature value by executing second transformation processing with respect to second input information including the extracted voice feature value, and
   a step of outputting character control information for controlling a character from the extracted frame feature value.

(5) An animation generation apparatus including
a voice feature value extraction unit that extracts a voice feature value using a voice model which takes voice data including human voice as input and which is trained to extract the voice feature value from the voice data by the model learning apparatus according to (1),
a character control information output unit that outputs character control information using a rig model which takes second input information including the voice feature value as input and which is trained to output the character control information for controlling a character from the second input information including the voice feature value by the model learning apparatus according to (1), and
an animation generation unit that generates an animation related to the character based on the character control information.

(6) An animation generation method including
a step of extracting a voice feature value using a voice model which takes voice data including human voice as input and which is trained to extract the voice feature value from the voice data using the model learning method according to (3),
a step of outputting character control information using a rig model which takes second input information including the voice feature value as input and which is trained to output the character control information for controlling a character from the second input information including the voice feature value using the model learning method according to (3), and
a step of generating an animation related to the character based on the character control information.

(7) An animation generation program causing a computer apparatus to execute
a step of extracting a voice feature value using a voice model which takes voice data including human voice as input and which is trained to extract the voice feature value from the voice data using the voice model learning program according to (4),
a step of outputting character control information using a rig model which takes second input information including the voice feature value as input and which is trained to output the character control information for controlling a character from the second input information including the voice feature value using the rig model learning program according to (4), and
a step of generating an animation related to the character based on the character control information.

What is claimed is:

1. A model learning system comprising:
one or more processors:
a non-transitory computer readable medium storing computer-executable instructions which, when executed, cause the one or more processors to perform operations comprising:
voice model learning including:
extracting an acoustic feature value by executing predetermined acoustic signal processing with respect to voice data including human voice; and
extracting a voice feature value by executing first transformation processing with respect to first input information including the extracted acoustic feature value; and
rig model learning including:
extracting a frame feature value by executing second transformation processing with respect to second input information including the extracted voice feature value, and
outputting character control information for controlling a character from the extracted frame feature value.

2. The model learning system of claim 1, further comprising:
a training data storage configured to store training data including voice and information related to an animation of the character as an answer,
wherein the operations further comprise updating parameters of the voice model and the rig model based on a difference between the information related to the animation of the character included in the training data and the character control information output using the training data.

3. A model learning method comprising:
extracting an acoustic feature value by executing predetermined acoustic signal processing with respect to voice data including human voice;
extracting a voice feature value by executing first transformation processing with respect to first input information including the extracted acoustic feature value;
extracting a frame feature value by executing second transformation processing with respect to second input information including the extracted voice feature value; and
outputting character control information for controlling a character from the extracted frame feature value.

4. A non-transitory computer-readable recording medium having recorded thereon instructions that when executed by a computer apparatus, cause the computer apparatus to perform operations comprising:
voice model learning including:
extracting an acoustic feature value by executing predetermined acoustic signal processing with respect to voice data including human voice; and
extracting a voice feature value by executing first transformation processing with respect to first input information including the extracted acoustic feature value; and
rig model learning including:
extracting a frame feature value by executing second transformation processing with respect to second input information including the extracted voice feature value; and
outputting character control information for controlling a character from the extracted frame feature value.

5. An animation generation system comprising:
one or more processors:
a non-transitory computer readable medium storing computer-executable instructions which, when executed, cause the one or more processors to perform operations comprising:
extracting a voice feature value using a voice model, the voice model configured to receive voice data comprising human voice as input and further configured to extract the voice feature value from the voice data, the voice model being trained by the model learning system of claim 1;
outputting character control information using a rig model, the rig model configured to receive second input information comprising the voice feature value as input and further configured to output the character control information for controlling a character from the second input information including the voice feature value, the rig model being trained by the model learning system of claim 1; and
generating an animation related to the character based on the character control information.

6. An animation generation method comprising:
extracting a voice feature value using a voice model, the voice model configured to receive voice data including human voice as input and further configured to extract the voice feature value from the voice data, the voice model being trained using the model learning method of claim 3;
outputting character control information using a rig model, the rig model configured to receive second input information including the voice feature value as input and further configured to output the character control information for controlling a character from the second input information including the voice feature value, the rig model being trained using the model learning method according to claim 3; and
generating an animation related to the character based on the character control information.

7. A non-transitory computer readable medium storing computer-executable instructions which, when executed, cause a computer apparatus to perform operations comprising:
extracting a voice feature value using a voice model configured to receive voice data including human voice as input and further configured to extract the voice feature value from the voice data, the voice model being trained by the voice model learning of claim 4;
outputting character control information using a rig model configured to receive second input information including the voice feature value as input and further configured to output the character control information for controlling a character from the second input information including the voice feature value, the rig model being trained by the rig model learning of claim 4; and
generating an animation related to the character based on the character control information.
